(19) United States
(12) Patent Application Publication
(10) Pub. No.: US 2002/0087380 A1
(43) Pub. Date: Jul. 4, 2002

(54) System and method for ameliorating subcontracting risk

(76) Inventors: Wanlong Wang, Rowland Heights, CA (US); Joseph T. Scarry, Chicago, IL (US); James G. Conley, Glencoe, IL (US)

Correspondence Address: PATENT ADMINSTRATOR, KATTEN MUCHIN ZAVIS, SUITE 1600, 525 WEST MONROE STREET, CHICAGO, IL, 60661, US

(21) Appl. No.: 09/977,013

(22) Filed: Oct. 12, 2001

Related U.S. Application Data
(60) Provisional application No. 60/239,870, filed on Oct. 13, 2000.

(51) Int. Cl. G06F 17/60

(52) U.S. Cl. 705/8

(57) ABSTRACT

A purchasing management system is disclosed which allows users to ameliorate “subcontracting risk” when placing orders for custom processed goods, through the agency of a “trustee” who holds key proprietary information belonging to both buyer and seller, and who releases it upon consent of the respective principals.

### CROSS-REFERENCE TO RELATED APPLICATIONS

This application claims the benefit of U.S. Provisional Application No. 60/239,870, filed Oct. 13, 2000, which is incorporated herein by reference.

### FIELD OF THE INVENTION

The present invention relates to the purchasing of any custom processed goods and a method for improving the predictability of the outcome of such purchases through the agency of a “trustee” who abets the appropriate flow of proprietary information between the prospective buyer and prospective sellers.

### BACKGROUND OF THE INVENTION

Contemporary product marketing processes involve greater and greater use of “outsourcing,” in which a single person or firm (the “principal”) assumes overall responsibility for the conception, production, marketing, and distribution of particular products, but delegates responsibility for individual steps (or sub-steps) in that process to other persons or firms (the “subcontractors”). Moreover, today's economy involves more and more “globalization”—in which principals are outsourcing from subcontractors at greater and greater distances. The present invention is concerned with the process of outsourcing or subcontracting of custom processing or manufacturing.

Outsourcing involves considerable risk for the principal. Since the principal assumes overall responsibility for coordinating and controlling a long chain of actions culminating in the final sale of a product to an end-user, the failure of any subcontractor in that chain can have negative consequences far in excess of the contract value of subcontracted step in question. The present invention is specifically concerned with ameliorating such “subcontracting risk.”

In general, responsibility for coordinating and controlling the subcontracting of manufacturing processes falls to the purchasing agent or purchasing manager (“PA”) within the firm. Ameliorating “subcontracting risk” is a substantial component of the PA's job. The PA's success at said process of amelioration is primarily dependent upon two key conditions:

(a) Disclosure by subcontractors to the PA, and subsequent analysis by the PA, of a substantial body of proprietary (but frequently not patent-protected) information of a sensitive, competitive nature, relating principally to the subcontractor's processing capabilities. It is upon the basis of this information that the PA can form a judgement about the rationality of entrusting a given processing operation(s) to a given subcontractor, and the risk that said processing operation(s) will not be successfully completed.

(b) Disclosure by the PA to the subcontractors of detailed processing instructions and/or product blueprints, which are also of a proprietary (but frequently not patent-protected), sensitive, competitive nature. It is upon the basis of this information that the subcontractor prepares a bid and warrants that he will successfully complete the work if awarded the order.

Both of these steps are plagued by an inefficient collection process. Because of the sensitive competitive nature of both types of information, PAs and prospective subcontractors face a difficult choice: (a) to invest substantial amounts of time to develop the personal trust necessary to convince counterparts to release the confidential information available, frequently involving “view only” opportunities that involve travel to the counterpart's site, or (b) to forgo the consideration of large numbers of candidates for subcontracting engagements, or (c) to undertake subcontracting engagements without regard to the risk involved. The globalization trend discussed above exacerbates this situation by increasing the distances that need to be traveled, the number of candidates who may have to be forgone, and the variability between the most capable and the least capable candidate subcontractors.

Furthermore, in addition to the problem of collecting or not collecting the relevant data, there exists a problem of coherently organizing it for successful analysis. Here, again, the globalization trend exacerbates the problem: more data loss/corruption between the collection step and the organization step due to increased distances between counterparts, multiplied by the increased number of candidates, complicated by the increased variability from candidate to candidate.

The fundamental inefficiency of this system is that the same data is being collected and organized multiple times, adding little or no value with each iteration, in sharp contrast to the considerable value added by the PA and his subcontractor counterpart in the process of analyzing data about processing capabilities relative to a particular processing assignment, and vice versa.

Accordingly, there is a need for a system and method capable of assisting a decision-maker to prospectively discern the degree of risk associated with a complex, multi-faceted purchasing decision.

### SUMMARY OF THE INVENTION

According to one aspect of the present invention, a method for ameliorating subcontracting risk includes generating and maintaining an audit for each of a number of suppliers; allowing a buyer to search the maintained audit data; based on the buyer's specified search criteria, generating a list of suppliers; allowing the buyer to request more detailed information from suppliers selected from the generated list; receiving permission from such selected suppliers to release such detailed information and releasing such detailed information to the buyer. A trustee may perform the intermediary steps between the buyer and supplier. The trustee may also submit the request for more detailed information to the selected suppliers. The request for more detailed information may be in the form of a request for information. The names of the suppliers in the list generated in response to the buyer's search may be unidentified. The generated list of suppliers may also be generated based on a hierarchy logic.

According to another aspect of the invention, the method may include the buyer reviewing the released supplier information; the buyer submitting proprietary information to a set of suppliers based on the buyer's review of released supplier information; the suppliers having an interest in the buyer's submission each preparing and transmitting a bid to the buyer in response and the buyer reviewing the proposed bids and making a purchase from one of the suppliers of interest. A trustee may perform these intermediary steps between the buyer and supplier as well. The buyer's submission of proprietary information may include a request for quotation. The method may further include implementing a project management system.

According to another aspect of the invention, a method for ameliorating subcontracting risk includes generating and maintaining an audit for each of a number of suppliers, wherein each audit evaluates the supplier's manufacturing processes; allowing a buyer to search the maintained audit data; and based on the buyer's specified search criteria, generating a list of suppliers. The method may further include allowing the buyer to request more detailed information from suppliers selected from the generated list; submitting the request for more detailed information to the selected suppliers; receiving permission from such selected suppliers to release such detailed information; and releasing such detailed information to the buyer. A trustee may perform the intermediary steps between the buyer and supplier. Also, the request for more detailed information may be in the form of a request for information. The names of the suppliers in the list generated in response to the buyer's search may be unidentified. The generated list of suppliers may be generated based on a hierarchy logic.

The method may further include the buyer reviewing the released supplier information; the buyer submitting proprietary information to a set of suppliers based on the buyer's review of released supplier information; the suppliers having an interest in the buyer's submission each preparing and transmitting a bid to the buyer in response; and the buyer reviewing the proposed bids and making a purchase from one of the suppliers of interest. A trustee may perform these intermediary steps as well. The buyer's submission of proprietary information may include a request for quotation. The method may further include implementing a project management system.

According to another aspect of the present invention, a system for ameliorating subcontracting risk includes a trustee for generating and maintaining an audit for each of a plurality of suppliers and a buyer, wherein the trustee allows the buyer to search the maintained audit data and generates a list of suppliers based on the buyer's search. The trustee may maintain the supplier audit data on a computer database and the buyers and suppliers may interact with the trustee's computer database through a computer. In one aspect of the system, the buyer may request more detailed information from suppliers selected from the generated list; the trustee submits the request for more detailed information to the selected suppliers and the trustee receives permission and releases such detailed information to the buyer.

According to another aspect of the invention, a system for ameliorating subcontracting risk includes a computing system on which an audit for each of a number of suppliers is maintained, wherein each audit evaluates the supplier's manufacturing processes.

### BRIEF DESCRIPTION OF THE DRAWINGS

These and other features, aspects, and advantages of the present invention will become better understood with regard to the following description, appended claims, and accompanying drawings where:

FIG. 1 is a non-exclusive list of the manufacturing processes to which the present invention is applicable;

FIG. 2a is an overview of principals in this business process;

FIG. 2b shows a preferred embodiment of the business process;

FIG. 2c shows the steps in an instance of communication between a buyer and a seller, and the trustee in using the current invention;

FIG. 3 is a detailed flow chart of the overall process;

FIG. 4 is a diagram illustrating the main components of an example Supplier Total Report and its relationship to communications enhancements made by the trustee;

FIGS. 5a-j are an example of a Supplier Total Report for a specific industry (cast metal);

FIG. 6 is an outline of a Project Management Report for a specific industry (cast metal); and

FIG. 7 illustrates the commercial process.

### DETAILED DESCRIPTION OF THE PREFERRED EMBODIMENTS

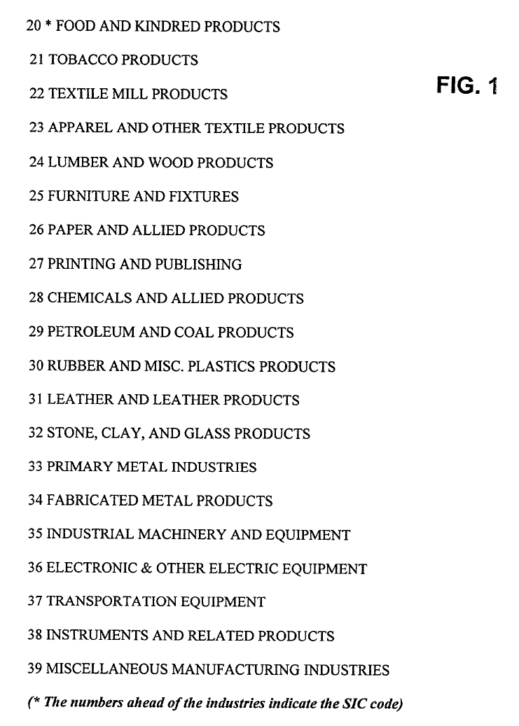

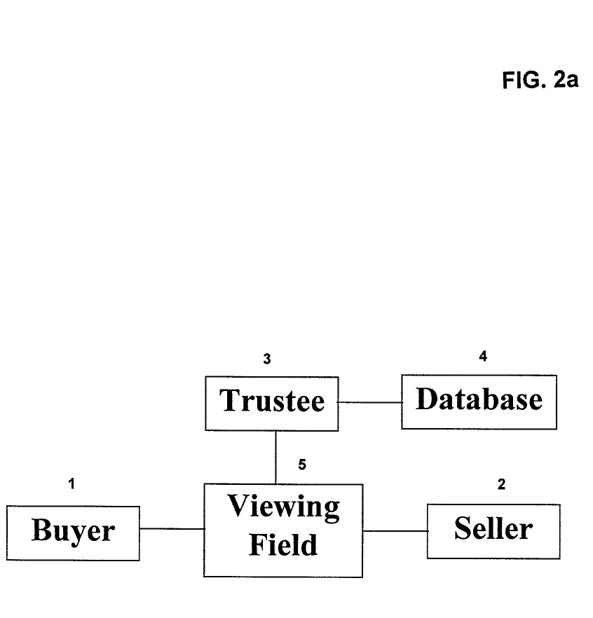

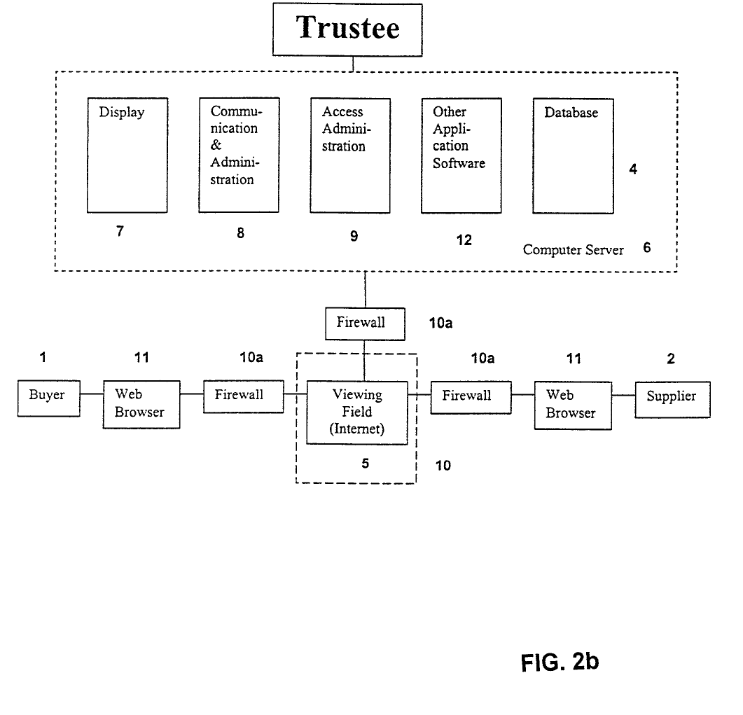

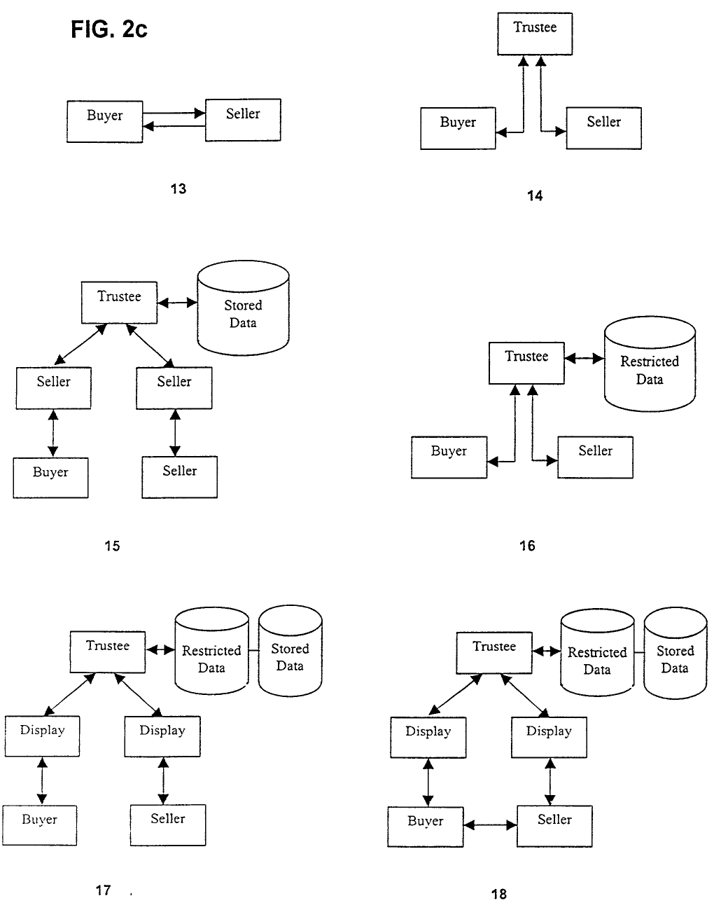

Referring to FIG. 1, a non-exclusive list of the manufacturing processes in which the system and method of the present invention may be practiced is provided. Referring to FIG. 2a, the principals in a preferred embodiment of the system and method of the present invention are generally depicted. The principals may include buyers 1, who are purchasers of custom manufactured and/or processed goods, sellers 2, who are specialized process manufacturers, especially any type of machine processing, and a trustee 3, who manages a database of information 4. There is a viewing field 5, which enables all three principals to view certain information, made available by the trustee from the database upon the consent of buyer(s) and/or seller(s). The “viewing field” may include standard-format versions of each party's respective proprietary information. The “viewing field” does not have to be a computerized display. The “viewing field” may also be figurative, in the sense, that the information may be exchanged by facsimile or any other method.

FIG. 2b shows a preferred embodiment in which the system utilizes a computer server 6 to store the database of information, supply all manner of displays 7 of information to the viewing field, administer communication between principals 8, and administer strict controls on access to proprietary data 9, and also embodies other types of applications software 12 to serve the needs of the system. In this preferred embodiment all principals are connected to the computer server through the Internet 10 using web browsers 11. In this embodiment, the viewing field is actually a combination of the web browsers (in the hands of all the principals) and the displays (generated by the trustee).

FIG. 2c shows the fundamental steps in any instance of communication between a buyer and a seller, and the trustee in using the current invention. Even in the absence of the current invention, communication between buyer and seller can take place directly 13 (“direct communication”). With the use of the current invention, there are added communication processes, in which, in the general case 14, communication from buyer to seller actually consists of communication from buyer to trustee, followed by communication from trustee to seller; and vice versa. In the current invention, there are four main variations on this general pattern. In one variation, equivalent to the general case 14, the trustee conveys messages directly and immediately between buyer and seller, with no significant processing (“unenhanced communication”). In a second variation 15, the trustee provides displays, often incorporating stored data, as a template for receiving communication input from one principal, and returns displays, also often incorporating stored data, as a setting for the communication output to the other principal (“enhanced communication”). In a third variation 16, the trustee manages access to restricted data for viewing by one of the other principals (“reporting communication”). Finally, there also exists a fourth variation 17, a hybrid of the second and third: “enhanced reporting communication.” Thus, it can be seen that the invention embraces all variation from “direct communication” to “enhanced reporting communication,” and everything in between 18.

In an embodiment of the invention, the sequence in which the consent is sought and obtained, and the information is displayed and viewed, is generally approximately as follows:

Step 1: “Create Auditing Standard/Protocol”—Trustee creates the auditing standard/protocol to evaluate the manufacturer's technical capability, production capacity, and management and service levels and the like according to purchasing agents' requirements.

Step 2: “Collect the Auditing Files”—The trustee conducts the auditing of the manufacturer's technical capability, production capacity, management and services, etc. according to the auditing standard/protocol to evaluate the business and technical aspects of the manufacturer and to verify such collected information.

Step 3: “Aggregate the Auditing Files”—Aggregate the auditing files of a whole industry in national or global scale into one centralized place. Provide the organizing, analyzing and categorizing ability for information filtering and retrieval.

Step 4: “Search for Qualified Manufacturers”—Buyer submits criteria for a processing contract/order to a search engine, which returns the names of processors whose capabilities audit indicates they are capable to meet the criteria.

Step 5: “Request for Information (RFI)”—Buyer transmits a brief description of the processing contract/order to the processors named in Step 4 (or some subset thereof), and requests that they indicate their interest in proceeding to the RFQ stage (Step 7) by providing to the trustee their consent for the buyer to view the full text of their capabilities audit.

Step 6: “Provision of Consent”—Suppliers who wish to proceed to the RFQ stage (Step 7) provide to the trustee their consent for the buyer to view the full text of their capabilities audit.

Step-7: “Display of Capabilities Audit”—The trustee displays the full text of the capabilities audit, per authorization in Step 6 above, for the buyer to view.

Step 8: “Request for Quotation (RFQ)”—The buyer selects a set of processors for receipt of “Request for Quotation (RFQ,” and causes said RFQ to be transmitted, through the trustee or otherwise, to the selected processors.

Step 9: Supplier Bid—Upon receipt of RFQ, processors calculate a bid, and cause said bid to be transmitted, through the trustee or otherwise, to the buyer.

Step 10: Buyer Response—Upon receipt of each bid, the buyer calculates a response, and causes said response to be transmitted, through the trustee or otherwise, to the supplier.

[Steps 9 and 10 are repeated as determined necessary by the buyer.]

Step 11: Order Placement—Upon the acceptance by the buyer of a given bid, the buyer causes to be transmitted, through the trustee or otherwise, a Purchase Order.

Step 12: Project Management—Subsequent to the transmission of the purchase order, the buyer causes a checklist to be sent to the supplier, consisting essentially of a list of points in the process at which the supplier shall be required to provide a status report to be provided, through the trustee or otherwise, to the buyer.

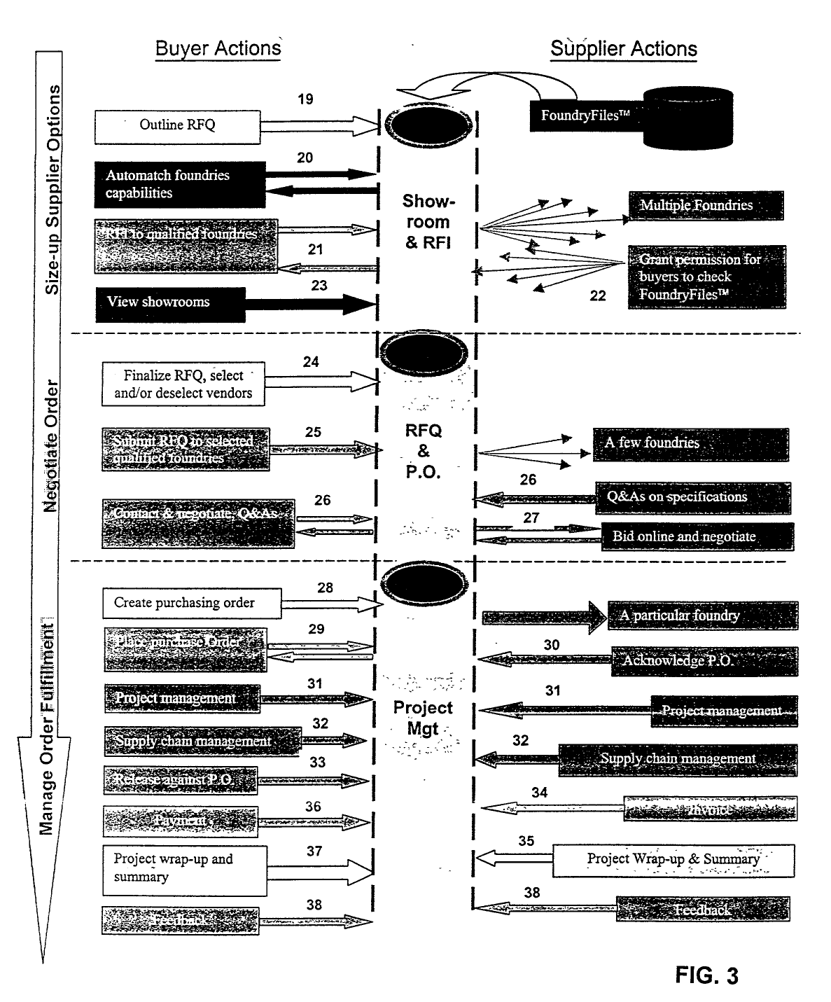

FIG. 3 is a detailed flow chart of an embodiment of the overall process described above, in which a buyer evaluates supplier options, a buyer and potential suppliers negotiate an order, and both sides manage fulfillment of the order. Supplier option evaluation consists of several steps. First the buyer summarizes the main parameters of the order he wishes to place 19 (“enhanced communication”). The buyer then automatches suppliers in the database to his indicated parameters 20 (“enhanced reporting communication”). After repeating steps 19 and 20 until he is satisfied that his stated parameters are returning a manageable field of suppliers, the buyer sends a request for information (RFI) 21 (“enhanced reporting communication”), inviting suppliers to provide access to their capabilities reports as a prerequisite for obtaining the buyer's formal Request for Quotation (RFQ). Interested suppliers grant permission 22 and buyers are enabled to view capabilities reports 23 (“enhanced reporting communication”).

Negotiation of an order between buyer and potential suppliers consists of several further steps. The buyer creates a Request for Quotation (RFQ) and selects the final list of vendors to whom he wishes to submit it 24 (“enhanced communication”). He submits the RFQ 25 (“enhanced communication”). Potential suppliers ask questions to clarify all details of the RFQ and the buyer provides answers 26 (“enhanced communication”). Potential suppliers provide bids against the RFQ and the buyer counterbids 27 (“enhanced communication”), a step which can be repeated any number of times.

Managing fulfillment of the order consists of several further steps. Upon reception of a satisfactory bid, the buyer creates a purchase order (PO) 28 (“enhanced communication”), and communicates that purchase order to the successful bidder 29 (“enhanced communication”). The successful bidder must confirm the purchase order 30 (“enhanced communication”) for it to be effective. Implementation of the order proceeds, with seller and buyer in frequent communication according to a project management protocol 31 (“enhanced reporting communication”) and a supply chain management protocol 32 (“enhanced reporting communication”). Shipments 34 are made either on a schedule incorporated in the original PO or upon notification by the buyer 33 (“enhanced communication”). Sellers invoice 35 (“enhanced communication”) upon shipment, and buyers make payment 36 (“enhanced communication”) upon receipt of invoice according to incorporated terms. Both buyer and seller receive a project summary 37 (“enhanced communication”) and have the option of providing feedback about the other side's performance in this transaction 38 (“enhanced reporting communication”). That feedback becomes part of the proprietary database.

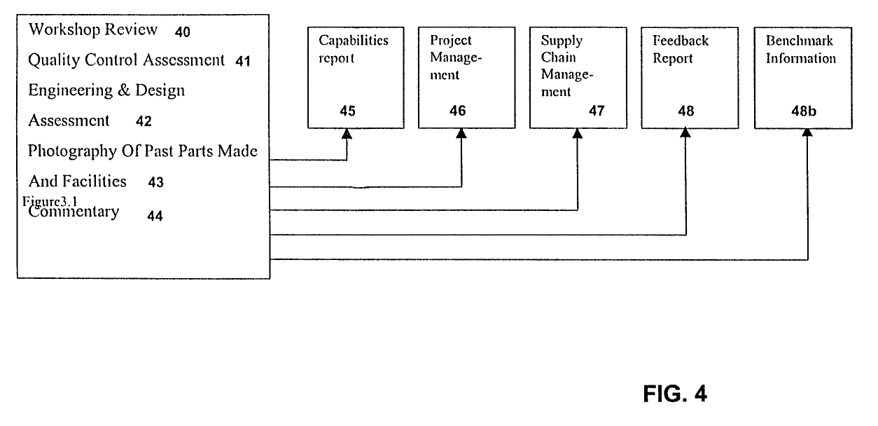

FIG. 4 is a diagram illustrating the main components of a Supplier Total Report 39 and its relationship to communications enhancements made by the trustee. The capabilities report incorporates several main categories of information, including workshop review 40, quality laboratory assessment 41, engineering & design center assessment 42, photography of actual products 43, and commentary by inspectors 44.

This data is, in turn, incorporated selectively in one or more of the following enhancements that the trustee provides to the buyer-seller communications process: capabilities report 45, project management report 46, supply chain management report 47, feedback report 48, and industry benchmark report 48b.

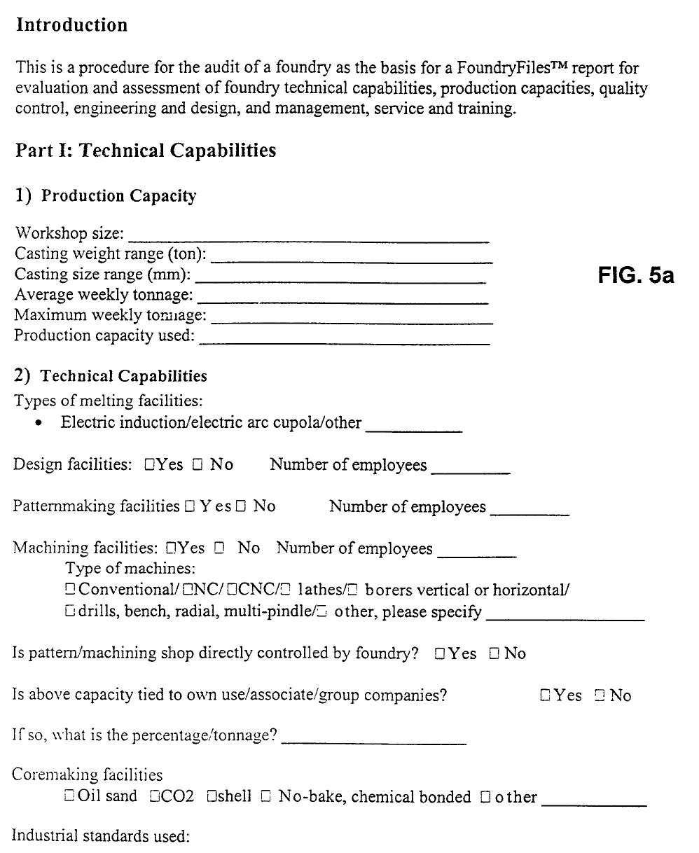

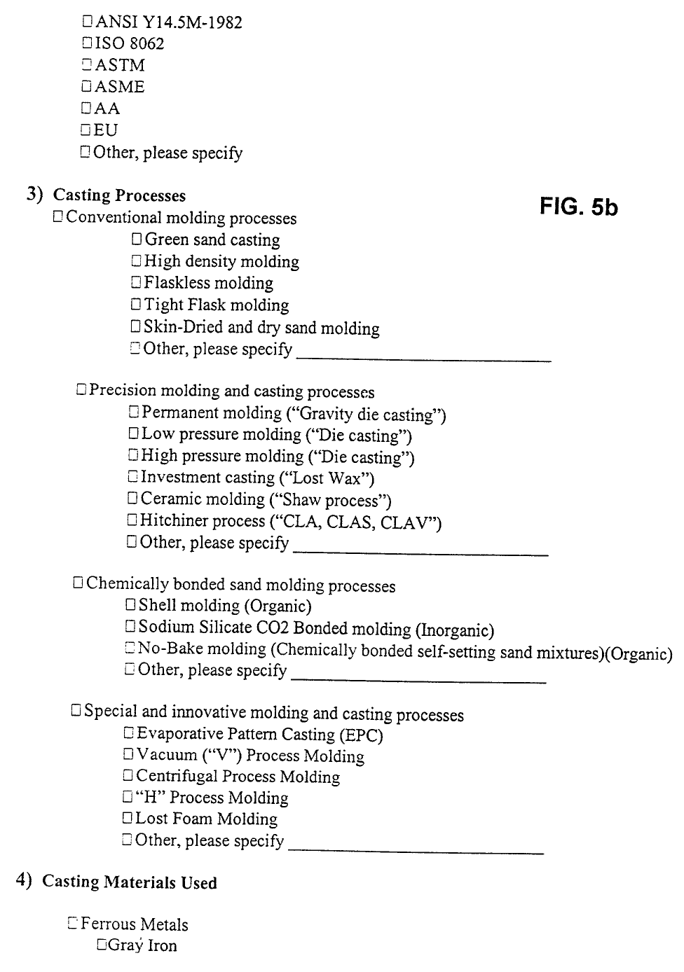

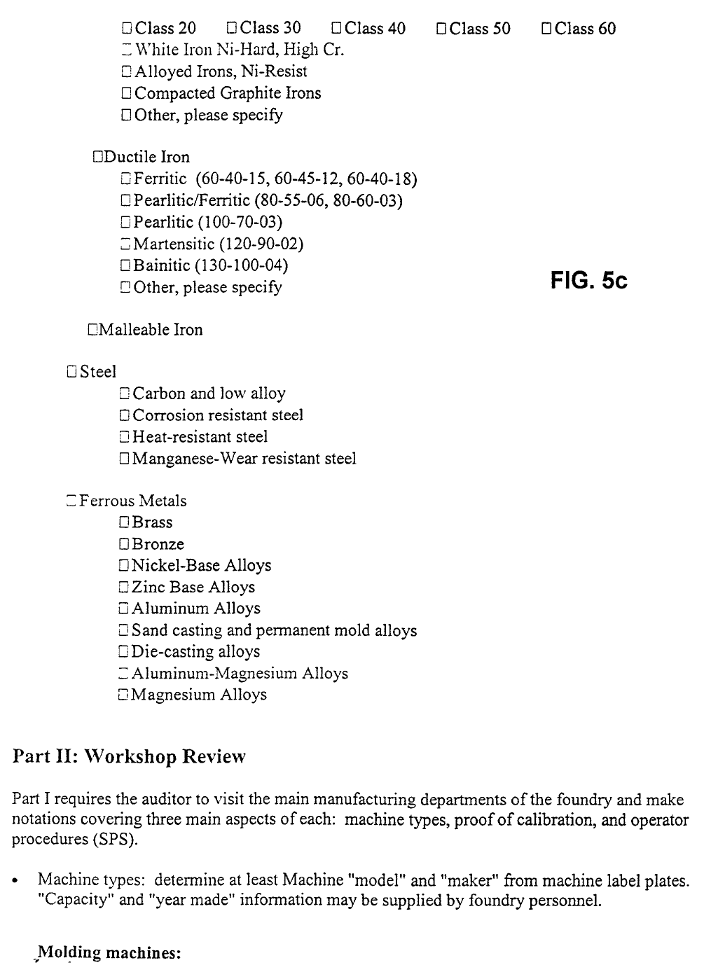

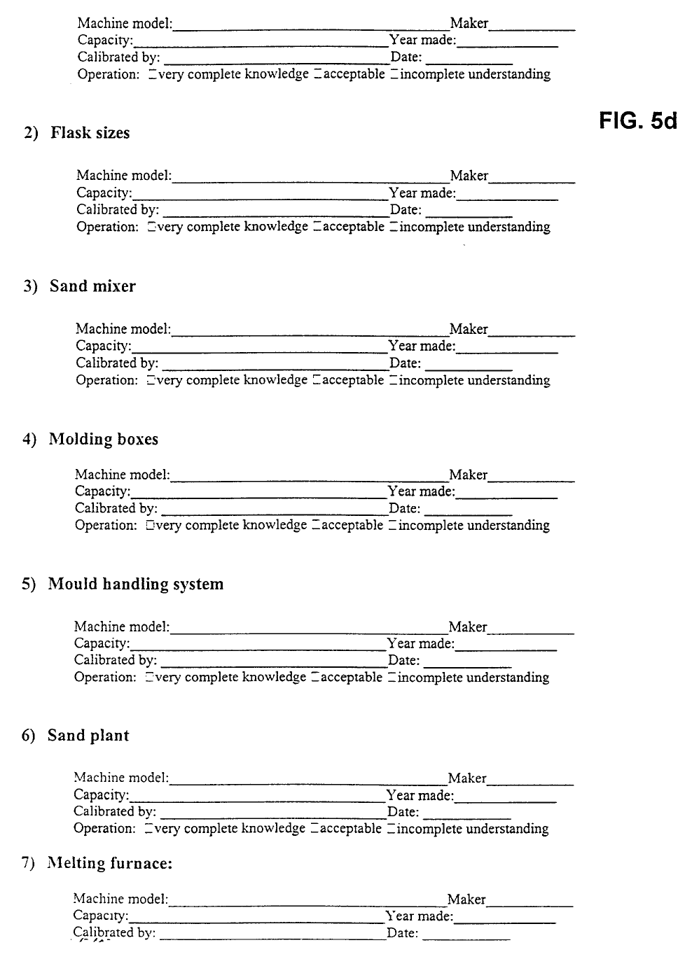

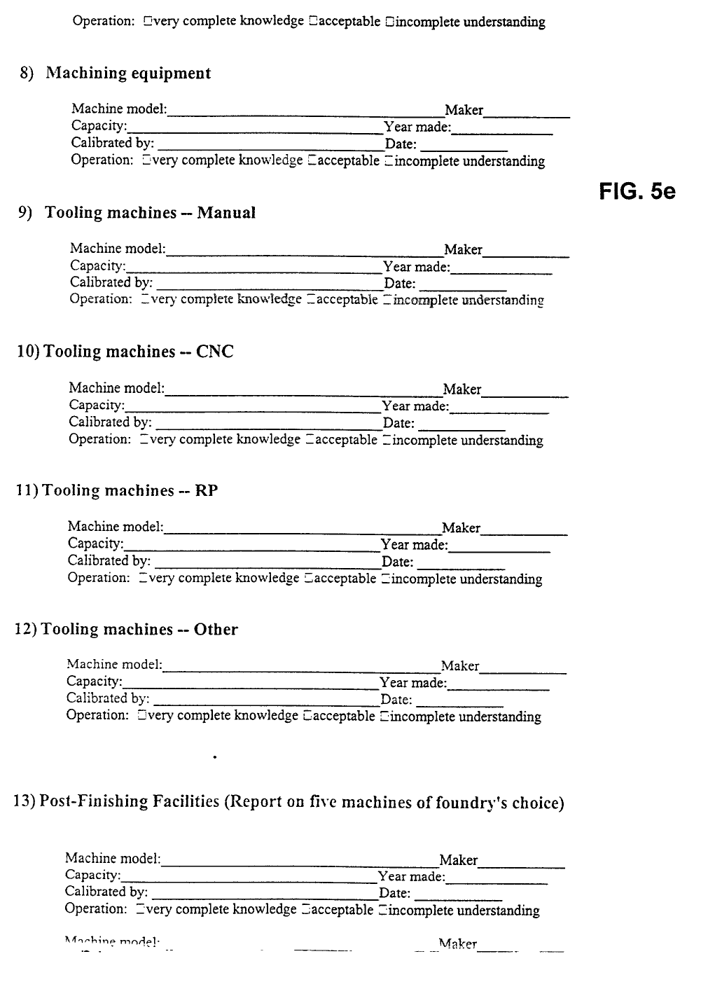

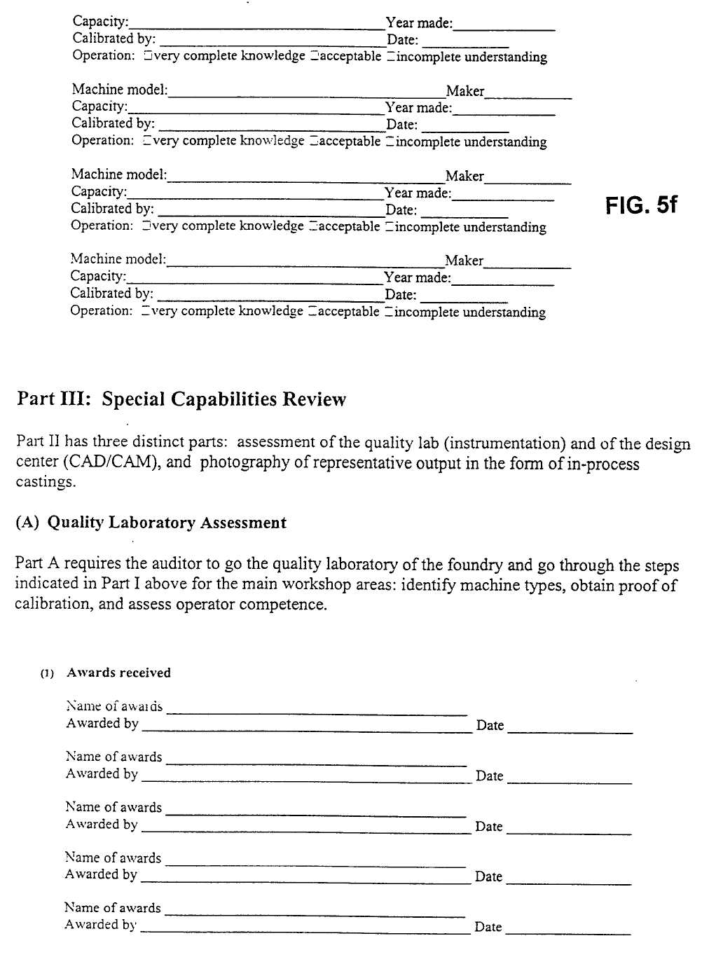

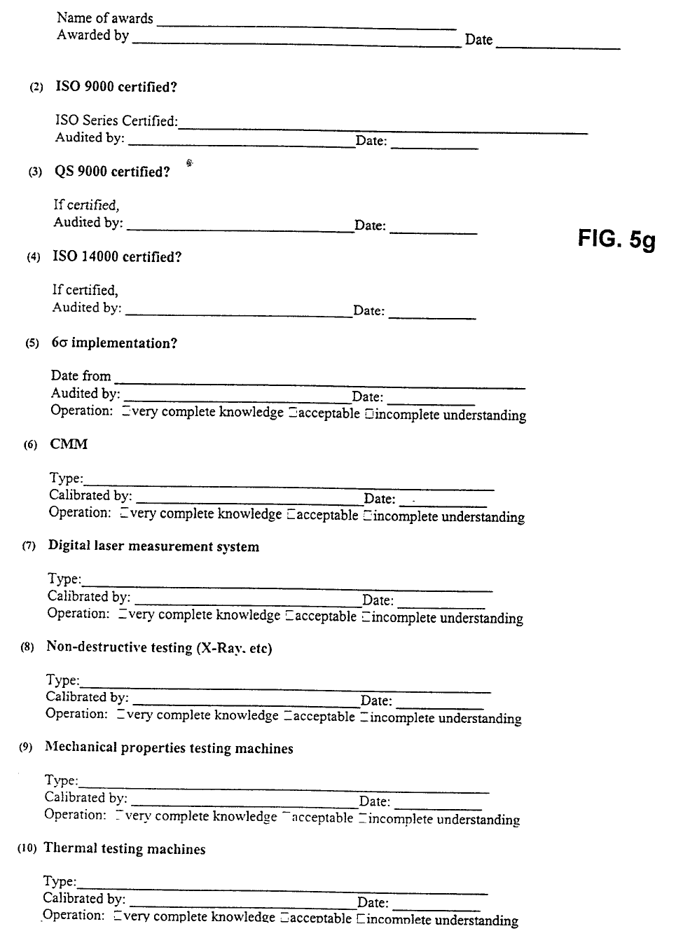

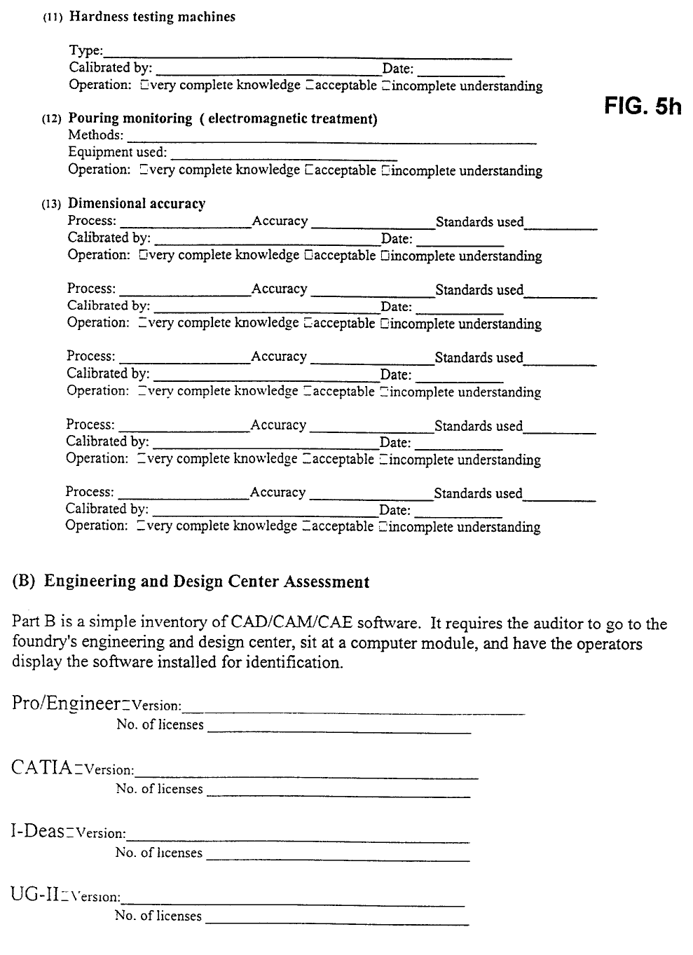

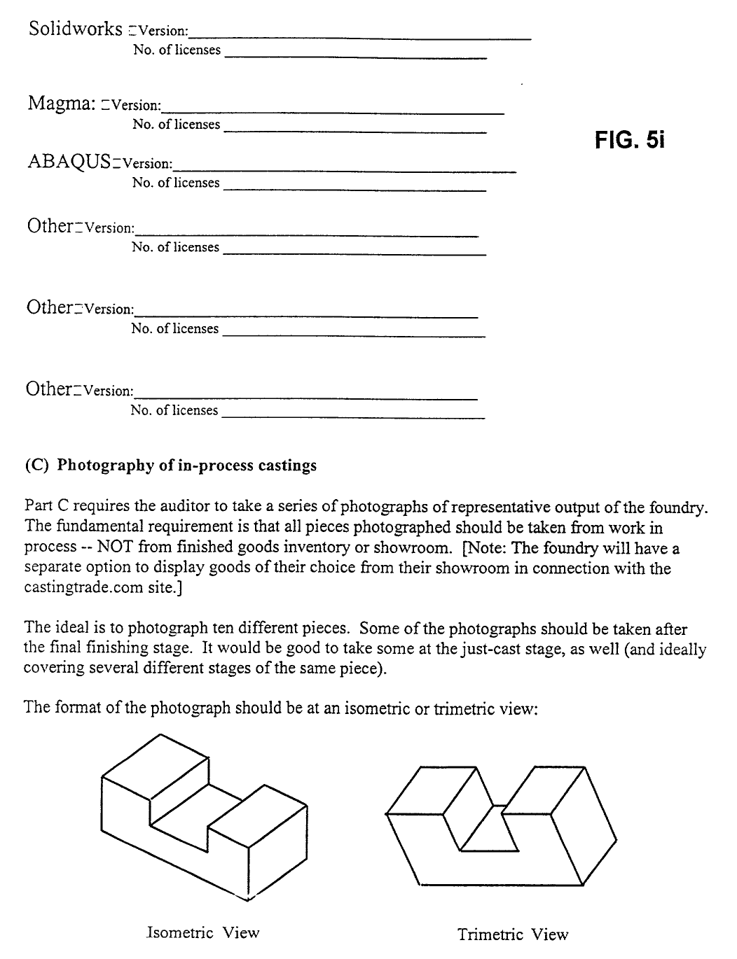

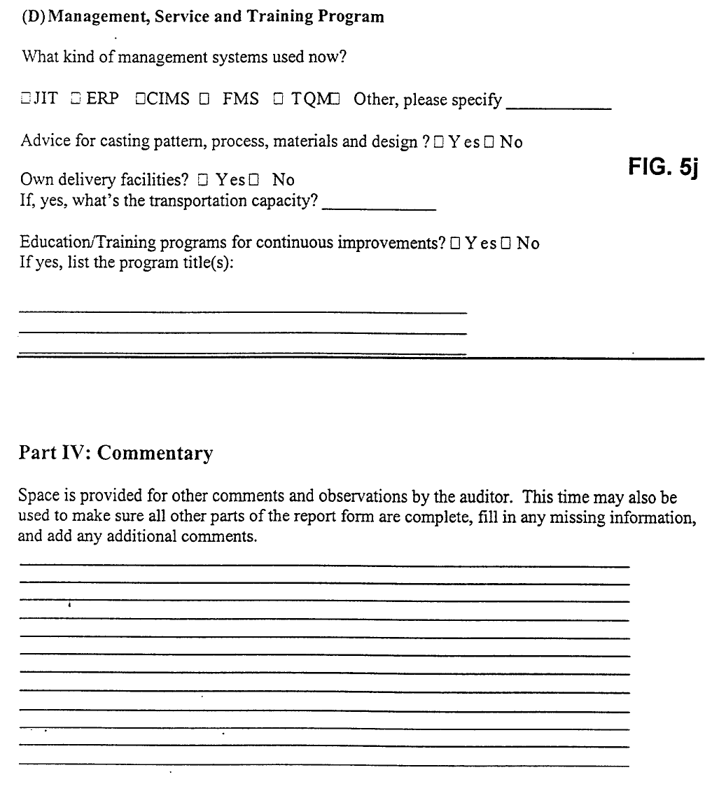

FIGS. 5a-j are an example of a Supplier Total Report for a specific industry (cast metal).

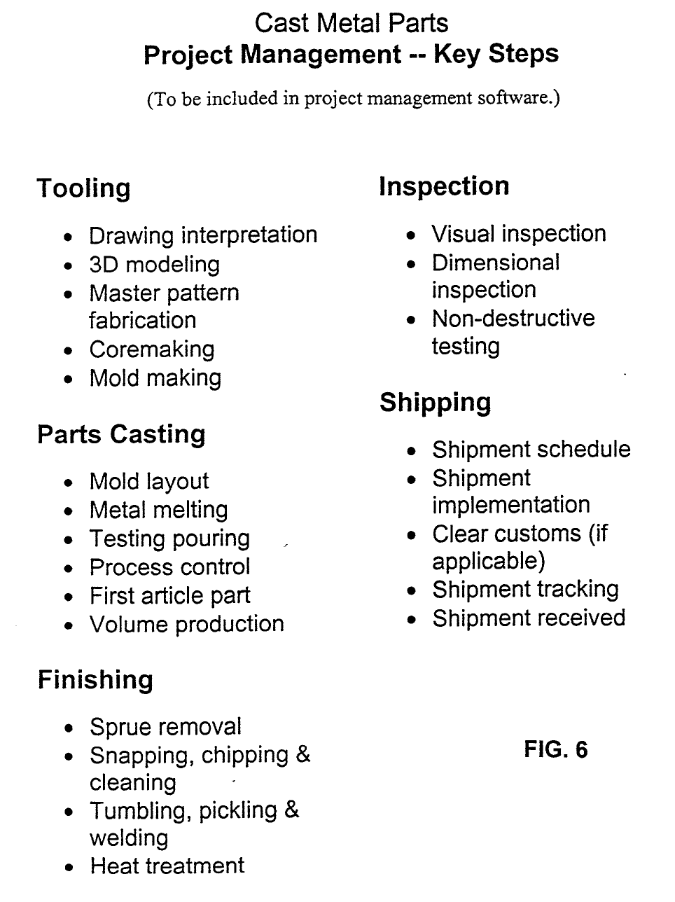

FIG. 6 is an outline of a Project Management Report for a specific industry (cast metal). Detailed line items on this chart would be keyed to specifics in the Supplier Total Report for the relevant supplier.

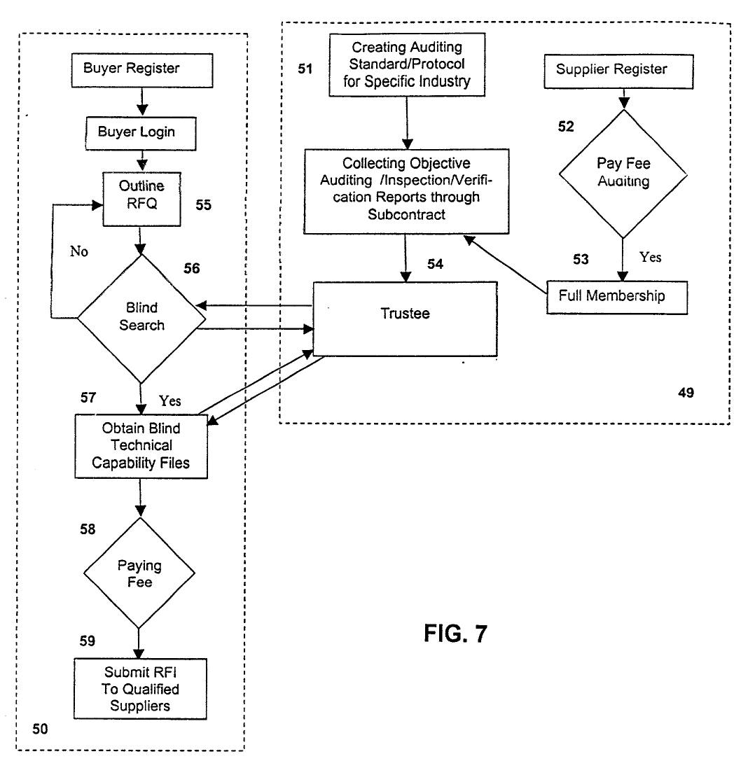

FIG. 7 illustrates an embodiment of a commercial process by which the trustee is remunerated for his role in the business process. This remuneration consists of two parts: collection of membership fees 49 and collection of handling fees 50.

The collection of membership fees requires three main steps. First, the trustee must create the standards and/or protocol according to which the standardized Supplier Total Reports for a specific industry shall be compiled 51. Second, individual suppliers agree to pay a fee for participation in the system 52. Finally, audits/inspections are conducted according to the standards/protocol 53 and the trustee enters the data into that supplier's Supplier Total Report 54.

The collection of handling fees requires a similar set of steps. First, a buyer accesses the trustee's server through their web browser and proceeds to summarize the main parameters of the order he wishes to place 55. Second, the buyer automatches suppliers in the database to his indicated parameters to obtain raw number of matches 56 and blind capability reports on matching suppliers 57. After repeating steps 55, 56, and 57 until he is satisfied that his stated parameters are returning a manageable field of suppliers, the buyer authorizes payment of a handling fee to the trustee 58 and submits a request for information (RFI) 59 through the system to relevant suppliers.

Although various preferred embodiments of the present invention have been described herein in detail, it will be appreciated by those skilled in the art, that variations may be made thereto without departing from the spirit of the invention or the scope of the appended claims.

What is claimed is:

1. A method for ameliorating subcontracting risk, comprising:
generating and maintaining an audit for each of a plurality of suppliers;
allowing at least one buyer to search the maintained audit data;
based on the buyer's specified search criteria, generating a list of suppliers;
allowing the buyer to request more detailed information from suppliers selected from the generated list;
receiving permission from such selected suppliers to release such detailed information; and
releasing such detailed information to the buyer.

2. The method of claim 1, wherein a trustee performs the intermediary steps between the buyer and supplier.

3. The method of claim 2, further comprising the trustee submitting the request for more detailed information to the selected suppliers.

4. The method of claim 1, wherein the request for more detailed information is a submission of a request for information.

5. The method of claim 1, wherein the suppliers in the list generated in response to the buyer's search are unidentified.

6. The method of claim 1, wherein the generated list of suppliers is generated based on a hierarchy logic.

7. The method of claim 1, further comprising:
the buyer reviewing the released supplier information;
the buyer submitting proprietary information to a set of suppliers based on the buyer's review of released supplier information;
the suppliers having an interest in the buyer's submission each preparing and transmitting a bid to the buyer in response; and
the buyer reviewing the proposed bids and making a purchase from one of the suppliers of interest.

8. The method of claim 7, wherein a trustee performs the intermediary steps between the buyer and supplier.

9. The method of claim 7, wherein the buyer's submission of proprietary information includes a request for quotation.

10. The method of claim 7, further comprising implementing a project management system.

11. A method for ameliorating subcontracting risk, comprising:
generating and maintaining an audit for each of a plurality of suppliers, wherein each audit evaluates the supplier's manufacturing processes;
allowing at least one buyer to search the maintained audit data; and
based on the buyer's specified search criteria, generating a list of suppliers.

12. The method of claim 11, further comprising:
allowing the buyer to request more detailed information from suppliers selected from the generated list;
submitting the request for more detailed information to the selected suppliers;
receiving permission from such selected suppliers to release such detailed information; and
releasing such detailed information to the buyer.

13. The method of claim 12, wherein a trustee performs the intermediary steps between the buyer and supplier.

14. The method of claim 12, wherein the request for more detailed information is a submission of a request for information.

15. The method of claim 11, wherein the suppliers in the list generated in response to the buyer's search are unidentified.

16. The method of claim 11, wherein the generated list of suppliers is generated based on a hierarchy logic.

17. The method of claim 12, further comprising:
the buyer reviewing the released supplier information;
the buyer submitting proprietary information to a set of suppliers based on the buyer's review of released supplier information;
the suppliers having an interest in the buyer's submission each preparing and transmitting a bid to the buyer in response; and
the buyer reviewing the proposed bids and making a purchase from one of the suppliers of interest.

18. The method of claim 17, wherein a trustee performs the intermediary steps between the buyer and supplier.

19. The method of claim 17, wherein the buyer's submission of proprietary information includes a request for quotation.

20. The method of claim 17, further comprising implementing a project management system.

21. A system for ameliorating subcontracting risk, comprising:
a trustee for generating and maintaining an audit for each of a plurality of suppliers, and a buyer, wherein the trustee allows the buyer to search the maintained audit data and generates a list of suppliers based on the buyer's search.

22. The system of claim 21, wherein the trustee maintains the supplier audit data on a computer database and the buyers and suppliers interact with the trustee's computer database through a computer.

23. The system of claim 21, wherein the buyer requests more detailed information from suppliers selected from the generated list, the trustee submits the request for more detailed information to the selected suppliers and the trustee receives permission and releases such detailed information to the buyer.

24. A system for ameliorating subcontracting risk, comprising:
a computing system on which an audit for each of a plurality of suppliers is maintained, wherein each audit evaluates the supplier's manufacturing processes.
